(19) United States
(12) Patent Application Publication
(10) Pub. No.: US 2016/0165511 A1
(43) Pub. Date: Jun. 9, 2016

(54) MOBILITY CONTROL FUNCTION FOR USER EQUIPMENT

(71) Applicant: TELEFONAKTIEBOLAGET L M ERICSSON (PUBL), Stockholm (SE)

(72) Inventors: Tomas HEDBERG, Stockholm (SE); Filip MESTANOV, Sollentuna (SE); Jari Tapio VIKBERG, Järna (SE)

(21) Appl. No.: 14/906,381

(22) PCT Filed: Aug. 22, 2013
(86) PCT No.: PCT/EP2013/067458

§ 371 Date: Jan. 20, 2016

(51) Int. Cl. H04W 36/30; H04W 76/04

(52) U.S. Cl. CPC H04W 36/30; H04W 76/046

(57) ABSTRACT

The present invention relates to a method at a first node in a first wireless network comprising a first mobility control function for a User Equipment, UE, connected to the first wireless network. The method includes the step of storing the identity of a second node in a second wireless network to which the UE is connected, the second node including a second mobility control function for the UE. When it is determined that the first mobility control function for the UE is transferring from the first node to a target node the identity of the target node and an indication that mobility control functionality for the UE is transferring from the first node to the target node, is transmitted to the second node or to the UE, or the identity of the second node and an indication that the second node includes the second mobility control function for the UE is transmitted to the target node or to the UE. A target node, upon receiving information relating to a first node at which the first mobility control function of a UE is currently located, an indication that first mobility control function for the UE is to be transferred from the first node to the target node, and an identity of a second node including a second mobility control function for the UE, transmits, to the second node, the identity of the target node and an indication that the first mobility control function for the UE is transferring from the first node to the target node.

### TECHNICAL FIELD

The present invention relates to control of a mobility control function for User Equipment when the User Equipment is connected simultaneously to two different networks. It is of particular use with User Equipments that are able to connect simultaneously to two different network types such as a Wi-Fi network and a 3GPP network.

### BACKGROUND

Data traffic in mobile telecommunications networks is continually increasing. Consequently, operators are employing heterogeneous access networks that utilise multiple radio access technologies (RATs) in order to provide greater capacity, particularly in high traffic areas and areas that otherwise have poor network coverage.

Typically, the radio access technologies utilised as part of these heterogeneous access networks include UMTS Radio Access Network (UTRAN) and an Evolved UTRAN (E-UTRAN), and Wi-Fi/WLAN. For example, FIG. 1 illustrates schematically a simplified example of a heterogeneous network 1 that comprises a 3GPP RAN 2 and a Wi-Fi RAN 3. The 3GPP RAN 2 includes a number of 3GPP radio nodes 4. For example, if the 3GPP RAN was a UTRAN, then these radio nodes would be Node Bs and Radio Network Controllers (RNC). By way of further example, if the 3GPP RAN was an E-UTRAN, then these radio nodes would be eNode Bs (eNB). The 3GPP RAN 2 is connected to a mobile core network (not shown)). The Wi-Fi RAN 3 includes a number of Wi-Fi/WLAN APs 5 that are connected to a Wi-Fi/WLAN Access Controller (AC) (not shown). The Wi-Fi/WLAN AC can control each of the Wi-Fi/WLAN APs 5 and implements authentication of a mobile station/user terminal that wants to associate with/attach to the Wi-Fi RAN/WLAN 3.

If the heterogeneous access network comprises a UTRAN, an E-UTRAN, and a Wi-Fi RAN/WLAN then both the UTRAN and E-UTRAN standards are defined by the 3rd Generation Partnership Project (3GPP), and the relevant 3GPP standards therefore define capabilities for handling load sharing between these 3GPP RANs. In contrast, the Wi-Fi/WLAN standards are defined by the Institute of Electrical and Electronics Engineers (IEEE).

A mobility control function has been developed within 3GPP RANs. The mobility control function is located within RAN controller nodes such as the BSC, RNC and eNode B. Each UE is provided with a mobility control function within an access network and this mobility control function controls which RAN the UE is connected to and determines when the UE is to transfer its connection to a different controller node either within the same RAN or a different RAN). For the sake of clarity, the term connected to a network is used within this document to encompass both a network where the UE is “connected” to a radio node or access point containing a mobility control function or a network where the UE is “associated” with the network for example where the mobility function for the UE is contained within a control node such as a Controller in a Wi-Fi/WLAN.

The mobility control function uses information stored locally in the access node in which it is located and also information received from the Core network to control the mobility of UE. The mobility control function may also use information from the UEs such as measurement reporting and UE capabilities when deciding when and if the UE is to be moved to another RAN. This move may also mean that the mobility control function controlling the UE is also moved to another RAN. For example, in the case of UE handover between two eNode Bs, if the mobility control function for the UE resides within the eNode B to which the UE is connected then when the UE moves from a source eNode B to a target eNode B the mobility control function is also moved from the source eNode B to the target eNode B. In another example, the mobility control function for the UE is moved between RAN controller nodes belonging to different radio accesses, for example from a source eNode B to a target RNC.

Currently, the mobility control function is being enhanced for use in Wi-Fi networks. A mobility control function in a Wi-Fi access network may be located, for example in a Wi-Fi/WLAN AP, a Wi-Fi/WLAN AC, a Controller or Gateway. Mobility control functions in the Wi-Fi network are able to talk both with mobility control functions within the Wi-Fi network and also the 3GPP network. This enables, for example, a mobility control function in a Wi-Fi network for a UE which is already connected to a 3GPP network and attempting to access the Wi-Fi network to connect to the mobility control for the UE in the 3GPP network to provide information available on the Wi-Fi side. For example, the mobility control for the UE in the Wi-Fi network informs the mobility control function for the UE present in the 3GPP network of the access attempt and the mobility control function for the UE present in the 3GPP network makes the decision if the access attempt is accepted or rejected. The decision is then sent from the mobility control function for the UE present in the 3GPP network to the mobility control for the UE in the Wi-Fi network.

An example of a known method of mobility control of the UE is outlined in FIG. 2. In FIG. 2, the UE is connected to an E-UTRAN network and the RAFC function for the UE resides in an eNode B in the network (S1). In this situation the mobility control function in the eNode B is responsible for all mobility decisions including Inter Radio Access Technology (IRAT) handover within the 3GPP network and Wi-Fi mobility. To connect to a Wi-Fi network the following steps are taken:

S2. The mobility control function for the UE in the 3GPP network transmits a message, such as an RRC Measurement Configuration message, to cause the UE to start searching for a Wi-Fi network to provide measurements for. The Wi-Fi network may be identified in the message using any suitable identification, for example the message may include one or more SSIDs (Service Set Identifiers), and/ or a PLMN-ID (public land mobile network identifier). The message may also include, for example, received signal strength indications (RSSI) conditions which must be satisfied by the Wi-Fi network. The UE, upon receiving the message at the 3GPP side, passes the message to the Wi-Fi part of the UE and the Wi-Fi part of the UE starts searching for an access point (AP) which satisfies the information stored in the message.

S3. When the UE finds an AP which matches the information stored in the message it retrieves information about the Wi-Fi network, for example the UE matches the SSID and other conditions like the RSSI by radio measurements. The UE may also need to perform Access Network Query Protocol (ANQP) signaling to verify the PLMN-ID and/or to retrieve any other information.

S4. The retrieved information is used to build an RRC measurement report that the Wi-Fi side of the UE forwards to the 3GPP side of the UE. The 3GPP side of the UE forwards the RRC measurement report to the mobility control function for the UE in the 3GPP network. Preferably, the message also contains a unique identifier of the Access Point.

S5. Based upon the received information and information available to the eNode B the mobility control function for the UE in the 3GPP network can decide to initiate handover or not. If the mobility control function decides not to initiate handover then no further action is taken. If the mobility control function decides to initiate the handover then a handover message such as an RRC Handover Command or Bearer Move Command message is sent to the UE. Preferably the AP is identified in the handover message using, for example, a basic service set identification (BSSID).

S6. The UE, upon receiving a handover message such as an RRC Handover Command message at its 3GPP side, passes the message to the Wi-Fi part of the UE and triggers the UE to perform connection procedures as defined, for example, in the 802.11 Standard to connect to the Wi-Fi network.

S7. When the connection procedures have been completed the UE is connected to the Wi-Fi network and the mobility control function for the UE that is present in the Wi-Fi network takes over control of mobility decisions for the UE.

As is clear from the method outlined above, responsibility for mobility decisions for the UE is taken by a single mobility control function, either in the 3GPP network or in the Wi-Fi network.

However, many UEs are capable of connecting to multiple access networks, whether 3GPP, Wi-Fi or another network, simultaneously. Currently, where a UE is simultaneously connected to multiple access networks the UE controls its mobility decisions. This is because if a mobility control function is present for the UE in each access network the UE is connected to different mobility control functions that may make different independent mobility decisions which may conflict. Therefore it is desirable to have a way to control mobility decisions for a UE when the UE is connected to multiple networks.

### SUMMARY

According to an aspect of the present invention there is provided first node in a first wireless network. The node includes a first mobility control function for a User Equipment, UE, connected to the first wireless network. The node further includes a memory, a transmitter and a processor. The memory stores the identity of a second node in a second wireless network to which the UE is connected, the second node including a second mobility control function for the UE. The processor, upon determining that the first mobility control function for the UE is transferring from the first node to a target node, causes the transmitter to transmit either the identity of the target node and an indication that mobility control functionality for the UE is transferring from the first node to the target node, to the second node or the UE, or the identity of the second node and an indication that the second node includes the second mobility control function for the UE to the target node. In this way mobility functions responsible for mobility decisions for the UE but present in different networks can be kept informed of changes in locations of other mobility functions for the UE.

The first node may transmit the identity of the second node and an indication that the second node includes the second mobility control function to the target node as part of a handover request message such as an RRC Handover Command or a Bearer Move Command message.

The target node may be located in a third wireless network and the first wireless network and the third wireless network is one of a 3GPP and WLAN network and the second wireless network is the other of a 3GPP and WLAN network. In this way mobility decisions for the UE can be taken both within a network and also between networks of different types.

According to another aspect of the present invention there is provided a method performed at a first node in a first wireless network comprising a first mobility control function for a User Equipment, UE, connected to the first wireless network. The method includes storing the identity of a second node in a second wireless network to which the UE is connected, the second node includes a second mobility control function for the UE. In response to determining that the first mobility control function for the UE is transferring from the first node to a target node, the identity of the target node and an indication that mobility control functionality for the UE is transferring from the first node to the target node, is transmitted to the second node or the UE. Alternatively, in response to determining that the first mobility control function for the UE is transferring from the first node to a target node, the identity of the second node and an indication that the second node includes the second mobility control function for the UE is transmitted to the target node.

Transmitting the identity of the second node and an indication that the second node includes a second mobility control function for the UE to the target node may take the step of transmitting a handover request.

The method may be performed where the target node is in a third wireless network. The first wireless network and the third wireless network are one of a 3GPP and WLAN network and the second wireless network is the other of a 3GPP and WLAN network.

According to an aspect of the present invention there is provided a target node in a network. The target node includes, at least, a receiver, a transmitter and a processor. The receiver receives, from a first node or a UE, an indication that a first mobility control function for the UE is to be transferred from the first node to the target node, and an identity of a second node in a second wireless network to which the UE is connected, the second node comprising a second mobility control function for the UE. The processor causes the identity of the target node and an indication that the first mobility control function for the UE is transferring from the first node to the target node to be transmitted to the second node by the transmitter.

The information relating to a first node at which the first mobility control function of a UE is currently located, an indication that first mobility control function for the UE is to be transferred from the first node to the target node, and an identity of the second node in the second wireless network to which the UE is connected, the second node comprising mobility control functionality for the UE may be received as part of a handover request message.

Optionally, the target node is in one of a 3GPP and WLAN network and the second wireless network is the other of a 3GPP and WLAN network.

According to a further aspect of the present invention there is provided a method, performed by a target node in a network. The method includes receiving an indication that a first mobility control function for the UE is to be transferred from a first node to the target node and receiving an identity of a second node in a second wireless network to which the UE is connected. The second node includes a second mobility control function which is also for the UE. The method further includes the target node transmitting, to the second node, the identity of the target node and transmitting, to the second node, an indication that the first mobility control function for the UE is transferring from the first node to the target node.

The target node may receive the information relating to a first node at which the first mobility control function of a UE is currently located, an indication that the first mobility control function for the UE is to be transferred from the first node to the target node, and an identity of the second node in the second wireless network to which the UE is connected, the second node comprising a second mobility control function for the UE as part of a handover request message.

According to an aspect of the present invention there is provided a second node in a second wireless network. The second node includes a second mobility control function for a UE, a memory, a receiver, a processor and a transmitter. The memory includes the identity of a first node at which a first mobility control function for the UE is located. The receiver receives the identity of a target node and an indication that the first mobility control function for the UE is transferring from the first node to the target node. The processor causes the transmitter of the second node to transmit, to the target node, the identity of the second node and an indication that the second mobility control function for the UE is located at the second node.

Optionally, the second node is in one of a 3GPP and WLAN network and the first node and target node are in a network that is the other of a 3GPP and WLAN network.

According to an aspect of the present invention there is provided a method performed at a second node. The second node including a second mobility control function for a UE. The method includes the steps of: receiving the identity of a target node and an indication that a first mobility control function for a UE is transferring from a first node to the target node and transmitting, to the target node, the identity of the second node and an indication that the second mobility control function for the UE is located at the second node.

According to an aspect of the present invention there is provided a User Equipment, UE, configured to be connected to a first wireless network and a second wireless network. The first wireless network includes a first node including a first mobility control function for the UE. The second wireless network includes a second node including a second mobility control function for the UE. The UE includes, at least, a receiver and a transmitter. The receiver is arranged to receive an indication that the first mobility control function is being moved from a first node to a target node. The transmitter is arranged to transmit, one of: the identity of the second node and an indication that a second mobility control function is located at the second node to the target node, or an indication that the mobility control function for the UE is being transferred from the first node to the target node to the second node, the indication including an identity of the target node.

Optionally, the first wireless network is one of a 3GPP and WLAN network and the second wireless network is the other of a 3GPP and WLAN network.

According to yet another aspect of the present invention there is provided a method in a User Equipment, UE, configured to be connected to a first wireless network and a second wireless network. The first wireless network includes a first node including a first mobility control function for the UE. The second wireless network includes a second node including a second mobility control function for the UE. The method comprises receiver, at the UE, an indication that the first mobility control function is being moved from the first node to a target node and the UE transmitting to the target node the identity of the second node and an indication that a second mobility control function is located at the second node or transmitting to the second node an indication that the first mobility control function for the UE is being transferred from the first node to the target node, the indication including an identity of the target node.

### BRIEF DESCRIPTION OF THE DRAWINGS

FIG. 1 illustrates an example of a heterogeneous network;

FIG. 2 is a flow diagram of a mobility decision implemented by a RAFC function;

FIG. 3 illustrates an example of a heterogeneous network in which the present invention may be implemented;

FIG. 4A is a flow diagram of a method according to the present invention;

FIG. 4B is a flow diagram of an alternative method according to the present invention;

FIG. 5 illustrates a 3GPP Radio Access Node for use in implementing the methods of FIG. 4A or 4B;

FIG. 6 illustrates a WLAN Access Point for use in implementing the methods of FIG. 4A or 4B; and

FIG. 7 illustrates a UE for use in implementing the methods of FIG. 4A or 4B.

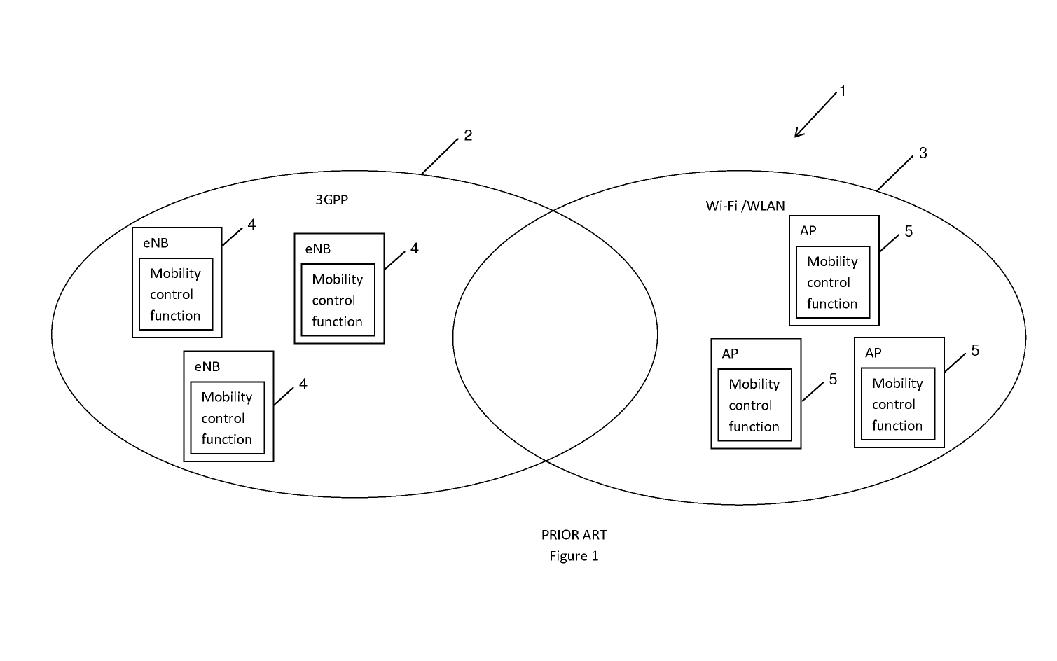

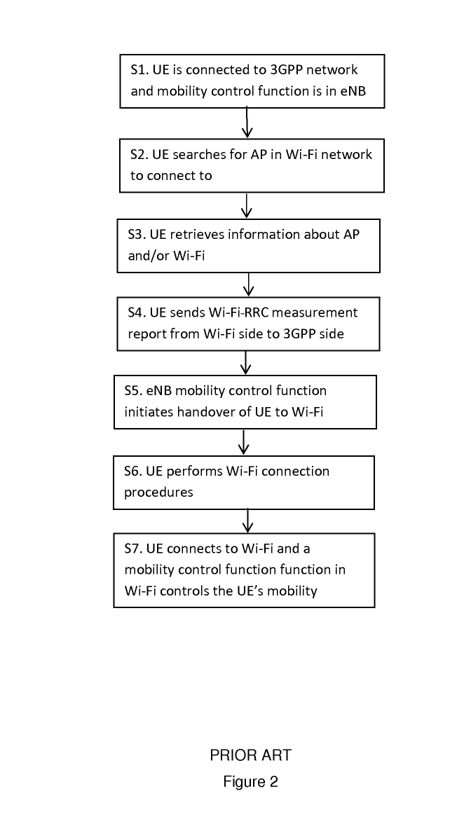

### DETAILED DESCRIPTION

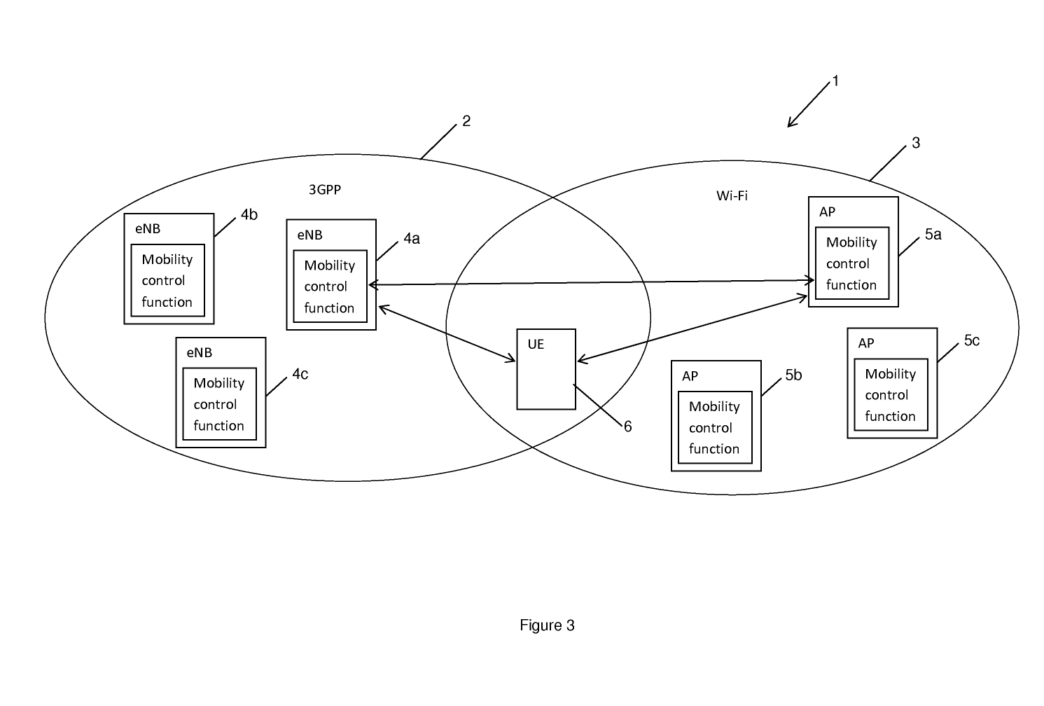

FIG. 3 illustrates schematically a simplified example of a heterogeneous network 1 in which the present invention may be implemented. Like reference numerals indicate like features. The heterogeneous network 1 comprises a 3GPP RAN 2 and a Wi-Fi RAN 3. The 3GPP RAN 2 is illustrated as an E-UTRAN and the eNode Bs 4a, 4b and 4c present within the network form Radio Access Nodes. Each of the eNode Bs 4a and 4b may include a mobility control function for a User Equipment (UE) connected to them. For example, in FIG. 3 eNode B 4a includes a mobility control function for UE 6 whereas eNode Bs 4b and 4c do not.

The Wi-Fi RAN 3 includes a number of Wi-Fi APs 5a, 5b and 5c that are connected to a Wi-Fi Access Controller (AC) (not shown). The Wi-Fi AC can control each of the Wi-Fi APs 5. Each of the Wi-Fi APs 5a, 5b and 5c may include a RAFC function for a User Equipment (UE) connected to them. For example, in FIG. 3 Wi-Fi APs 5a will include a mobility control function for UE 6 whereas eNode Bs 5b and 5c do not.

Hereinafter a mobility control function implemented in a node in a 3GPP network will be referred to as a 3GPP-mobility control function and a mobility control function implemented in a node in a Wi-Fi network will be referred to as a Wi-Fi-mobility control function.

In the present invention the 3GPP-mobility control function and Wi-Fi-mobility control function for the UE 6 are aware of each other and are able to communicate with each other. Examples of how the 3GPP-RAFC function and Wi-Fi-RAFC function begin communicating are provided in U.S. patent application Ser. No. 61/803618 filed on 20 Mar. 2013 and patent application number PCT/SE2013/050830 filed on 28 Jun. 2013 which are hereby incorporated by reference.

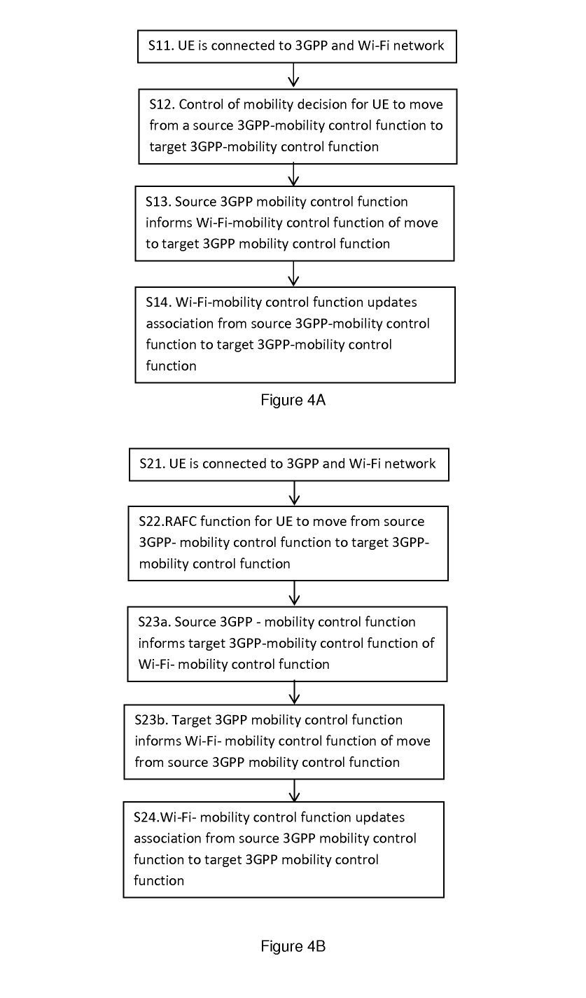

Turning now to FIG. 4a, which illustrates a method of maintaining communication between the mobility control functions for the UE 6 illustrated in FIG. 3 when the 3GPP-mobility control function for the UE moves nodes. The method includes the steps of:

S11. The UE is initially connected to both a 3GPP network and a Wi-Fi network as described with reference to FIG. 3 and therefore has a 3GPP-mobility control function and associated Wi-Fi-mobility control function which are in communication with each other.

S12. The node providing the 3GPP-mobility control function for the UE is to change, for example, this may be because the UE is to transfer its connection to another eNode B in the 3GPP network. Therefore the mobility control function responsible for mobility decisions for the UE in the 3GPP network is to change from being at a source 3GPP-mobility control function present in the current eNode B to a target 3GPP-mobility control function present in a different eNode B such as one of eNode B 4b or 4c.

S13. The source 3GPP-mobility control function transmits a message to the Wi-Fi-mobility control function for the UE informing the Wi-Fi-mobility control function that the mobility control function in charge of mobility decisions for the UE in the 3GPP network is to change to the target 3GPP-mobility control function. The message includes, at least an indication of a change in the location of the mobility control function taking mobility decisions for the UE, and an identity of the location of the target 3GPP-mobility control function. Preferably, the message also includes an identifier for the target 3GPP-mobility control function in charge of the UE in order that the correct mobility control function can be identified. This message may be transmitted before, after or simultaneously to the transfer of the responsibility for mobility decisions to the target 3GPP-mobility control function.

S14. The Wi-Fi-mobility control function updates the location of the 3GPP-mobility control function and initiates communication with the target 3GPP-mobility control function. Preferably, the communication initiated by the Wi-Fi-mobility control function is at least partly based on the identifier for the target 3GPP-mobility control function in charge of the UE in order that the correct mobility control function can be identified.

FIG. 4b, illustrates an alternative method of maintaining communication between the mobility control functions for a UE 6 that is connected to two separate networks as illustrated in FIG. 3 when the 3GPP-mobility control function for the UE moves. The method includes the steps of:

S21. The UE is initially connected to both a 3GPP network and a Wi-Fi network as described with reference to FIG. 3 and therefore has a 3GPP-mobility control function and associated Wi-Fi-mobility control function which are in communication with each other.

S22. The node providing the 3GPP-mobility control function is to change. Therefore the mobility control function responsible for mobility decisions for the UE in the 3GPP network is to change from a source 3GPP-mobility control function present in the current eNode B to a target 3GPP-mobility control function present in a different eNode B such as one of the eNode Bs 4b, 4c.

S23a. The source 3GPP-mobility control function transmits a message to the target 3GPP-mobility control function for the UE informing the target 3GPP-mobility control function that mobility decisions for the UE in the Wi-Fi network are taken by the Wi-Fi-mobility control function. The message includes, at least, an identity of the location of the Wi-Fi-mobility control function and an indication that the Wi-Fi-mobility control function is responsible for mobility decisions for the UE in the Wi-Fi network. Preferably, the message also includes an identifier for the Wi-Fi-mobility control function in charge of the UE in order that the correct mobility control function can be identified. This message may be transmitted after or as part of any handover related message sent from the source 3GPP-mobility control function to the target 3GPP-mobility control function.

S23b. The target 3GPP-mobility control function transmits a message to the Wi-Fi-mobility control function for the UE informing the Wi-Fi-mobility control function that mobility decisions for the UE in the 3GPP network is to move to the target 3GPP-mobility control function. The message includes, at least an indication of a change in the location of mobility decisions, and an identity of the location of the target 3GPP-mobility control function. Preferably, the message also includes the identifier for the Wi-Fi-mobility control function in charge of the UE in order that the correct mobility control function can be identified. This message may be transmitted before, after or simultaneously to the transfer of the responsibility for mobility decisions to the target 3GPP-mobility control function (using any defined procedures for this purpose, for example PS handover).

S24. The Wi-Fi-mobility control function updates the location of the 3GPP-mobility control function from the source 3GPP-mobility control function to the target 3GPP-mobility control function and any further communication is with the target 3GPP-mobility control function.

A further alternative method is that the UE, upon being informed of the movement of the 3GPP-mobility control function from the source 3GPP-mobility control function to the target 3GPP-mobility control function transmits a message to the Wi-Fi-mobility control function informing the Wi-Fi-mobility control function that mobility decisions for the UE in the 3GPP network is to move to the target 3GPP-mobility control function. The message includes, at least an indication of a change in the location of mobility decisions, and an identity of the location of the target 3GPP-mobility control function. Alternatively, the UE may transmit a message to the target node including, at least, the identity of the Wi-Fi node and an indication that the Wi-Fi mobility control function for the UE is located at the Wi-Fi node.

Although the embodiments of the invention described above have been described with reference to movement of the mobility control function within the 3GPP network it will be understood that the methods discussed above may also be applied to the instance where the mobility control function for the UE in the Wi-Fi network moves and the mobility control function for the UE in the Wi-Fi network stays constant.

It is possible that the location of the mobility control function changes in both the 3GPP and the Wi-Fi networks alters simultaneously the source 3GPP-mobility control function may attempt to implement the method described in FIG. 4A. The Wi-Fi-mobility control function will no longer contain a context for the UE and therefore cannot update its association. In such an instance the Wi-Fi-mobility control function may have knowledge of the new Wi-Fi-mobility control function that the UE context has been moved to. If the Wi-Fi-mobility control function does have knowledge of the location of the new Wi-Fi-mobility control function for the UE then it can either send a message to the new Wi-Fi-mobility control function informing the new Wi-Fi- mobility control function of the target 3GPP-mobility control function or, alternatively, the Wi-Fi-mobility control function may send a message to the source 3GPP-mobility control function to inform the source 3GPP-mobility control function that the context for the UE has moved to the new Wi-Fi-mobility control function.

If the Wi-Fi-mobility control function sends a message to the new Wi-Fi-mobility control function informing the new Wi-Fi-mobility control function of the target 3GPP-mobility control function then the target Wi-Fi-mobility control function can send a message to the target 3GPP-mobility control function informing the target 3GPP-mobility control function of the movement of the UE context to the new Wi-Fi-mobility control function. The message may take any suitable format.

If the Wi-Fi-mobility control function sends the message to the source 3GPP-mobility control function then the source 3GPP-mobility control function, upon receiving the message, will transmit a message to the target 3GPP-mobility control function informing the target 3GPP-mobility control function of the new Wi-Fi-mobility control function. The message may take any suitable format.

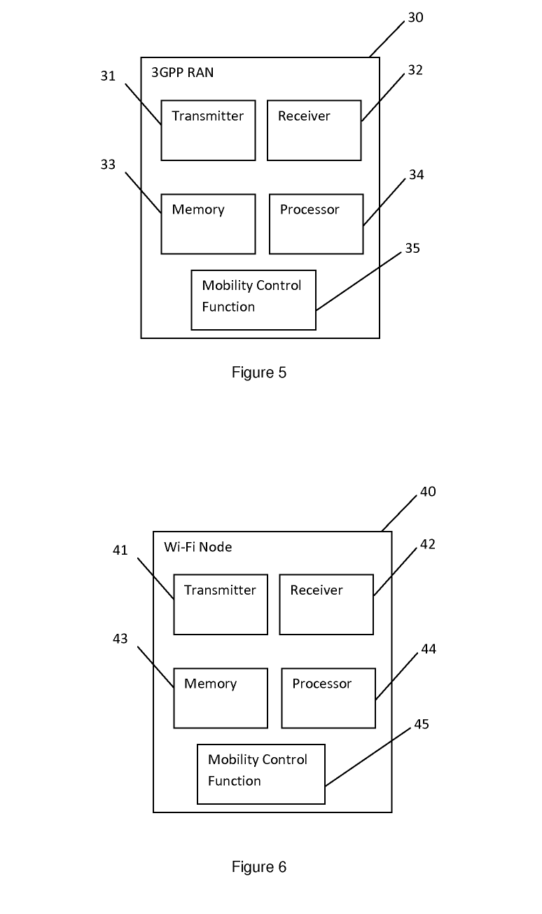

FIG. 5 schematically illustrates an embodiment of a 3GPP Radio Access Node, RAN, 30 such as eNode B 4a and 4b, according to the present invention. The node is configured to implement a mobility control function 35 on suitable hardware. The 3GPP-RAN 30 comprises at least a receiver 32 for receiving, for example, a message from a Wi-Fi-AP that the mobility control function for the UE present in the Wi-Fi network is to move to another Wi-Fi-AP.

The 3GPP-RAN 30 further comprises a transmitter 31 for transmitting, for example, a message to the target 3GPP-mobility control function for the UE informing the target 3GPP-mobility control function that mobility decisions for the UE in the Wi-Fi network are taken by a Wi-Fi-mobility control function. The 3GPP-RAN 30 further comprises a memory 33 and a processor 34, wherein the processor 34 is configured to generate the message to be sent to the target 3GPP-mobility control function, for example. The memory 33 is configured to store an identity of a location of a Wi-Fi-mobility control function at least.

FIG. 6 schematically illustrates an embodiment of a Wi-Fi node 40 such as a Wi-Fi AP 5a, 5b, according to the present invention. The node is configured to implement a mobility control function function 45 on suitable hardware. The Wi-Fi node 40 comprises at least a receiver 42 for receiving, for example, an indication that the mobility control function making mobility decisions for the UE in a 3GPP network is to move to a target 3GPP-RAN from a 3GPP-RAN. The indication that the mobility control function making mobility decisions for the UE is to move to a target 3GPP-RAN is preferably sent by the source 3GPP-RAN.

The Wi-Fi node 40 further comprises a transmitter 41 for transmitting, for example, a message to a target node including a target Wi-Fi-mobility control function informing the target Wi-Fi-mobility control function that mobility decisions for the UE in the 3GPP network are taken by the 3GPP-mobility control function. The Wi-Fi node 40 further comprises a memory 43 and a processor 44, wherein the processor 44 is configured to generate the message to be sent to the target Wi-Fi node 40, for example. The memory 43 is configured to store an association between a mobility control function it contains for a UE and any additional mobility control functions for that UE of which it is aware.

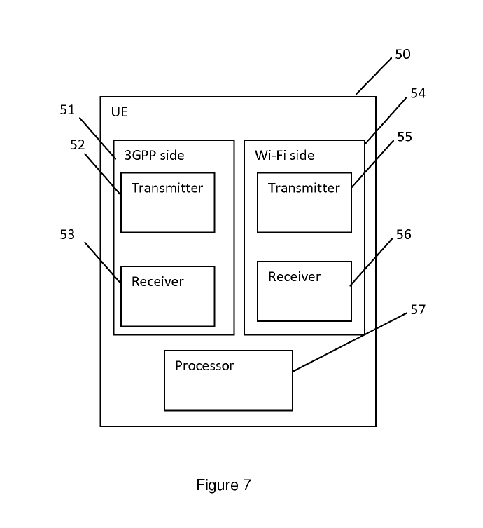

FIG. 7 schematically illustrates an embodiment of a UE 50 for use in the present invention. The UE 50 is configured to exchange control and data messages with two different network types, in this instance a 3GPP network and a Wi-Fi network. To achieve this, the UE has a 3GPP side 51 including, at least, a transmitter 52 and a receiver 53 to transmit and receive messages respectively with a 3GPP network. The UE also has a Wi-Fi side 54 including, at least, a transmitter 55 and a receiver 56 to transmit and receive messages respectively with a 3GPP network. The UE 50 also includes at least one processor 57 to process messages received on one or other of the 3GPP and Wi-Fi side.

As will be understood by the skilled person, although the present invention has been described with reference to Wi-Fi and 3GPP networks it is applicable to any combination of networks which have separate mobility control functionality for a single UE. It will also be understood that although the methods are described above with reference to mobility control functions residing in a Wi-Fi AP and a 3GPP eNode B they are applicable to any node on which a mobility control function resides. In particular, although not necessarily they can be applied when mobility control functions reside on and move between any suitable node such as RAN controller nodes such as the BSC, RNC and eNode B in a 3GPP network or in a Wi-Fi/WLAN AP, a Wi-Fi/WLAN AC, a Controller or Gateway.

The messages transmitted between two mobility control functions may take any suitable format.

1. A first node in a first wireless network, the node comprising a first mobility control function for a User Equipment, UE, connected to the first wireless network, the node comprising:
a memory storing the identity of a second node in a second wireless network to which the UE is connected, the second node including a second mobility control function for the UE;
a transmitter; and
a processor configured to, upon determining that the first mobility control function for the UE is transferring from the first node to a target node, cause the transmitter to transmit one of: the identity of the target node and an indication that mobility control functionality for the UE is transferring from the first node to the target node, to the second node or the UE; and the identity of the second node and an indication that the second node includes the second mobility control function for the UE to the target node.

2. A first node in a network as claimed in claim 1 wherein, the identity of the second node and an indication that the second node includes the second mobility control function for the UE is comprised in a handover request message transmitted to the target node.

3. A first node in a network as claimed in claim 1 wherein, the target node is in a third wireless network and the first wireless network and the third wireless network are one of a 3GPP and WLAN network and the second wireless network is the other of a 3GPP and WLAN network.

4. A method comprising, at a first node in a first wireless network comprising a first mobility control function for a User Equipment, UE, connected to the first wireless network,
storing the identity of a second node in a second wireless network to which the UE is connected, the second node including a second mobility control function for the UE,
determining that the first mobility control function for the UE is transferring from the first node to a target node,
transmitting, in response to the determining, one of: the identity of the target node and an indication that mobility control functionality for the UE is transferring from the first node to the target node, to the second node or the UE; and the identity of the second node and an indication that the second node includes the second mobility control function for the UE to the target node.

5. A method as claimed in claim 4 wherein, the identity of the second node and an indication that the second node includes a second mobility control function for the UE is comprised in a handover request transmitted to the target node.

6. A method as claimed in claim 4 wherein, the target node is in a third wireless network and the first wireless network and the third wireless network are one of a 3GPP and WLAN network and the second wireless network is the other of a 3GPP and WLAN network.

7. A target node in a network comprising:
a receiver configured to receive an indication that a first mobility control function for the UE is to be transferred from a first node to the target node, and an identity of a second node in a second wireless network to which the UE is connected, the second node comprising a second mobility control function for the UE,
a transmitter, and
a processor configured to cause the transmitter to transmit, to the second node, the identity of the target node and an indication that the first mobility control function for the UE is transferring from the first node to the target node.

8. A target node as claimed in claim 7 wherein, the information relating to a first node at which the first mobility control function of a UE is currently located, an indication that first mobility control function for the UE is to be transferred from the first node to the target node, and an identity of the second node in the second wireless network to which the UE is connected, the second node comprising mobility control functionality for the UE is received in a handover request message.

9. A target node as claimed in claim 8 wherein, the target node is in one of a 3GPP and WLAN network and the second wireless network is the other of a 3GPP and WLAN network.

10. A method at a target node in a network comprising receiving an indication that a first mobility control function for the UE is to be transferred from a first node to the target node, and receiving an identity of a second node in a second wireless network to which the UE is connected, the second node comprising a second mobility control function for the UE; and transmitting, to the second node, the identity of the target node and transmitting, to the second node, an indication that the first mobility control function for the UE is transferring from the first node to the target node.

11. A method as claimed in claim 10 wherein, the information relating to a first node at which the first mobility control function of a UE is currently located, an indication that the first mobility control function for the UE is to be transferred from the first node to the target node, and an identity of the second node in the second wireless network to which the UE is connected, the second node comprising a second mobility control function for the UE is received in a handover request transmitted to the target node.

12. A second node in a second wireless network comprising:
a second mobility control function for a UE;
a memory including the identity of a first node at which a first mobility control function for the UE is located
a receiver configured to receive the identity of a target node and an indication that the first mobility control function for the UE is transferring from the first node to the target node,
a transmitter and
a processor configured to cause the transmitter to transmit, to the target node, the identity of the second node and an indication that the second mobility control function for the UE is located at the second node.

13. A second node as claimed in claim 12 wherein, the second node is in one of a 3GPP and WLAN network and the first node and target node are in a network that is the other of a 3GPP and WLAN network.

14. A method at a second node having a second mobility control function for a UE, comprising: receiving the identity of a target node and an indication that a first mobility control function for a UE is transferring from a first node to the target node and transmitting, to the target node, the identity of the second node and an indication that the second mobility control function for the UE is located at the second node.

15. A User Equipment, UE, configured to be connected to a first wireless network and a second wireless network, the first wireless network comprising a first node comprising a first mobility control function for the UE and the second wireless network comprising a second node comprising a second mobility control function for the UE, the UE comprising
a receiver to receive an indication that the first mobility control function is being moved from a first node to a target node, and
a transmitter to transmit, one of: the identity of the second node and an indication that a second mobility control function is located at the second node to the target node, or an indication that the mobility control function for the UE is being transferred from the first node to the target node to the second node, the indication including an identity of the target node.

16. A User Equipment, UE, as claimed in claim 15 wherein, the first wireless network is one of a 3GPP and WLAN network and the second wireless network is the other of a 3GPP and WLAN network.

17. A method comprising, a User Equipment, UE, configured to be connected to a first wireless network and a second wireless network, the first wireless network comprising a first node comprising a first mobility control function for the UE and the second wireless network comprising a second node comprising a second mobility control function for the UE, receiving an indication that the first mobility control function is being moved from the first node to a target node, and transmitting to the target node the identity of the second node and an indication that a second mobility control function is located at the second node or transmitting to the second node an indication that the first mobility control function for the UE is being transferred from the first node to the target node, the indication including an identity of the target node.

18. A method as claimed in claim 17 wherein,. the first wireless network is in one of a 3GPP and WLAN network and the second wireless network is the other of a 3GPP and WLAN network.

19. (canceled)
